(19) United States
(12) Patent Application Publication
(10) Pub. No.: US 2022/0002485 A1
(43) Pub. Date: Jan. 6, 2022

(54) METHOD FOR SYNTHESIZING DIHYDROXYL-TERMINATED POLYPHENYLENE OXIDE OLIGOMER

(71) Applicant: Institute of Chemical Engineering, Guangdong Academy of Sciences, Guangzhou, Guangdong (CN)

(72) Inventors: Yuliang MAI, Guangzhou, Guangdong (CN); Benbin ZHONG, Guangzhou, Guangdong (CN); Weihao LI, Guangzhou, Guangdong (CN); Xiaoquan PENG, Guangzhou, Guangdong (CN); Ke XU, Guangzhou, Guangdong (CN)

(73) Assignee: Institute of Chemical Engineering, Guangdong Academy of Sciences, Guangzhou, Guangdong (CN)

(21) Appl. No.: 17/289,713

(22) PCT Filed: Jan. 2, 2019
(86) PCT No.: PCT/CN2019/070032

§ 371 Date: Apr. 28, 2021

(51) Int. Cl. C08G 65/44; B01J 31/12

(52) U.S. Cl. CPC C08G 65/44; B01J 31/12

(57) ABSTRACT

Disclosed is a method for synthesizing dihydroxyl-terminated polyphenylene oxide oligomer. The method for synthesizing dihydroxyl-terminated polyphenylene oxide oligomer, comprising oxidatively copolymerizing monohydric phenol and dihydric phenol in the presence of a metal-polyethyleneimine complex as a catalyst, to obtain the dihydroxyl-terminated polyphenylene oxide oligomer. The synthesizing method of the present disclosure uses a metal-polyethyleneimine complex as a catalyst, which has a milder catalytic activity, can effectively promote the reaction between the dihydric phenol and the monohydric phenol, increases the hydroxyl content of the product, meanwhile reduces the amount of the residual dihydric phenol monomer in the product, so that the quality of the product can be improved. The dihydroxyl-terminated polyphenylene oxide oligomer prepared can be used as additive and copolymerization block in other thermoplastic plastics, thermoplastic elastomers and thermosetting materials, thereby improving the performances of the material, such as thermal performance, adhesion, mechanical property, chemical resistance, and electrical property.

### CROSS-REFERENCE TO RELATED APPLICATIONS

The present application is a national phase entry under 35 USC § 371 of International Application PCT/CN2019/070032, filed Jan. 2, 2019, which claims the benefit of and priority to Chinese Patent Application No. 2018112651919, filed Oct. 29, 2018, the entire disclosures of which are incorporated herein by reference.

### TECHNICAL FIELD

The present disclosure relates to a method for synthesizing dihydroxyl-terminated polyphenylene oxide oligomer.

### BACKGROUND

Rapid development of the information industry puts forward higher requirements on matrix resin for copper clad laminate, such as low dielectric constant and dielectric loss, high glass transition temperature, high heat resistance, and low water absorption. Polyphenylene oxide resin (PPO) is one of five general engineering plastics in the world, the molecular structure of which is an aromatic ring skeleton chain with high rigidity, having no strong polar groups. Polyphenylene oxide resin has good heat resistance, flame retardancy, low moisture absorption, and dimensional stability, especially excellent dielectric property in a wide temperature range, being one of ideal substitute materials for high-performance copper clad laminate.

However, the conventional polyphenylene oxide resins have high melt viscosity, poor fluidity, and poor compatibility with most other resins, and phase separation is prone to occur after curing, which limits the use of traditional high-molecular-weight polyphenylene oxides in the copper clad laminate. Compared with the conventional polyphenylene oxides, the dihydroxyl-terminated polyphenylene oxide oligomer not only maintain the original excellent property of polyphenylene oxide, but also have the advantages such as low viscosity, good fluidity, good compatibility with other resins, and good thermal performance at a glass transition temperature, which is suitable for the matrix resin of composite materials in the high-frequency circuit board or the additive component of other polymer materials.

At present, the polyphenylene oxide oligomers are mainly obtained by redistribution method and copolymerization method. In CN101389691A, it adopts the redistribution method to prepare a low-molecular-weight polyphenylene oxide, under the action of a peroxide initiator, a high-molecular-weight polyphenylene oxide and a polyphenolic compound are radicalized, and the radicalized polyphenolic compound captures a part of the polyphenylene oxide structure unit so as to form a dihydroxyl-terminated polyphenylene oxide oligomer. In this method, a large amount of initiator needs to be introduced and the process time is long; meanwhile, the molecular weight distribution of the obtained product is uneven, and some of the high molecular weight polyphenylene oxides remain as residue. In CN101305030A, it adopts a copolymerization method to prepare polyfunctional polyphenylene oxides, comprising oxidatively copolymerizing monohydric phenol and polyhydric phenol in the presence of a copper-amine complex as a catalyst to form polyfunctional polyphenylene oxides. In this catalytic system, small molecules are used as a ligand, such as alkylenediamine, primary monoamines, secondary monoamines, tertiary monoamines, aminoalcohols, oximes, oxines, and cyanides. Monohydric phenol monomer has a high homopolymerization activity and a low reaction activity with polyphenol in this catalytic system. Thus, it is difficult to control the copolymerization process and obtain a product with a higher hydroxyl functionality, meanwhile, there are many polyhydric phenol monomers that have not involved in the reaction, therefore, the production requirement is difficult to meet.

### SUMMARY

In view of the defects existing in the prior art, the present disclosure aims at providing a method for synthesizing dihydroxyl-terminated polyphenylene oxide oligomer, and solving the problems in the conventional catalytic system such as low reaction activity between the monohydric phenol and the polyphenol, and high amount of residual polyphenol monomer.

The technical scheme of the present disclosure is as follows:

A method for synthesizing dihydroxyl-terminated polyphenylene oxide oligomer, comprising oxidatively copolymerizing monohydric phenol and dihydric phenol in the presence of metal-polyethyleneimine complex as a catalyst, to obtain the dihydroxyl-terminated polyphenylene oxide oligomer.

The structure of the dihydroxyl-terminated polyphenylene oxide oligomer is as shown in formula (I):

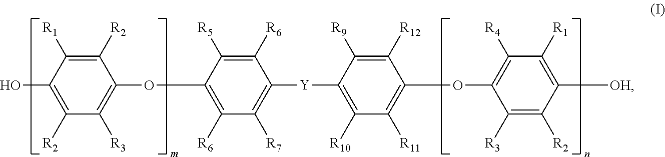

wherein, in formula (I), m and n are respectively an integer greater than or equal to 0;

R₁, R₂, R₃, R₄, R₅, R₆, R₇, R₈, R₉, R₁₀, R₁₁, or R₁₂ independently represents a hydrogen atom, an alkyl group, a phenyl group, an alkoxy group, an aminoalkyl group, halogen or a halogenated alkyl group;

Y has a structure selected from the following:

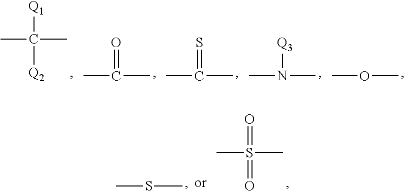

or Y is not present, wherein Q₁, Q₂, or Q₃ respectively independently represents a hydrogen atom, an alkyl group or a halogenated alkyl group;

the number average molecular weight of the dihydroxyl-terminated polyphenylene oxide oligomer is 800˜8000.

Preferably, in the method for synthesizing dihydroxyl-terminated polyphenylene oxide oligomer, the metal-polyethyleneimine complex is a complex formed from a metal salt and a polyethyleneimine ligand; further, the metal-polyethyleneimine complex is a complex of the metal salt and the polyethyleneimine ligand in a solution.

Preferably, in the metal-polyethyleneimine complex, the metal salt is at least one selected from the group consisting of copper salt, manganese salt, cobalt salt, and iron salt; more preferably, the metal salt is copper salt, namely, the metal-polyethyleneimine complex is a complex of the copper salt and the polyethyleneimine ligand in a solution.

Preferably, in the metal-polyethyleneimine complex, the polyethyleneimine ligand is at least one selected from the group consisting of linear polyethyleneimine, branched polyethyleneimine, and alkylated polyethyleneimine. More preferably, the polyethyleneimine ligand is alkylated polyethyleneimine.

Preferably, in the metal-polyethyleneimine complex, the number average molecular weight (Mn) of the polyethyleneimine ligand is 500˜10000. More preferably, the number average molecular weight (Mn) of the polyethyleneimine ligand is 500˜2000.

Preferably, in the metal-polyethyleneimine complex, the molar ratio of the polyethyleneimine ligand to the metal is (0.3˜15):1.

Preferably, in the method for synthesizing dihydroxyl-terminated polyphenylene oxide oligomer, the monohydric phenol has a structure as shown in formula (II):

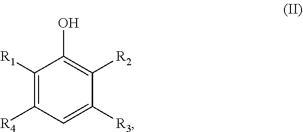

wherein, in the formula (II), R₁, R₂, R₃, or R₄ respectively independently represents a hydrogen atom, an alkyl group, a phenyl group, an alkoxy group, an aminoalkyl group, halogen or a halogenated alkyl group.

More preferably, in the method for synthesizing dihydroxyl-terminated polyphenylene oxide oligomer, the monohydric phenol is 2,6-dimethylphenol.

Preferably, in the method for synthesizing dihydroxyl-terminated polyphenylene oxide oligomer, the dihydric phenol has a structure as shown in formula (III):

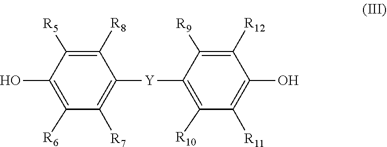

wherein, in the formula (III), R₅, R₆, R₇, R₈, R₉, R₁₀, R₁₁, or R₁₂ respectively independently represents a hydrogen atom, an alkyl group, a phenyl group, an alkoxy group, an aminoalkyl group, halogen or a halogenated alkyl group.

Y has a structure selected from the following:

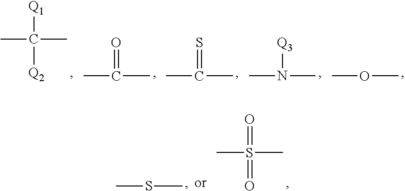

or Y is not present, wherein Q₁, Q₂, or Q₃ respectively independently represents a hydrogen atom, an alkyl group or a halogenated alkyl group. If Y is not present, the two benzene rings in the dihydric phenol are directly connected, as shown in formula (IV):

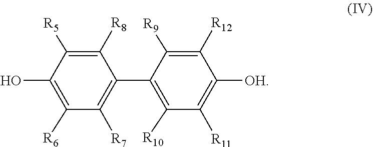

More preferably, in the method for synthesizing dihydroxyl-terminated polyphenylene oxide oligomer, the dihydric phenol is at least one selected from the group consisting of bisphenol A, bisphenol F, tetramethyl bisphenol A, and tetramethyl bisphenol F.

Preferably, in the method for synthesizing dihydroxyl-terminated polyphenylene oxide oligomer, the method comprises the following steps:

1) in a reactor, dissolving the monohydric phenol and the dihydric phenol in a solvent, then adding a solution of the polyethyleneimine ligand and the metal salt, and performing an oxidative copolymerization reaction under the action of an oxidant, to obtain a polymer solution;

2) mixing and reacting the polymer solution obtained in step 1) with a chelating agent solution, then separating and extracting an oil phase product;

3) concentrating and purifying the oil phase product obtained in step 2), to obtain the dihydroxyl-terminated polyphenylene oxide oligomer having the structure of formula (I).

Preferably, in step 1) of the synthesizing method, the molar ratio of the monohydric phenol to the dihydric phenol is (2˜20):1.

Preferably, in step 1) of the synthesizing method, the molar ratio of the polyethyleneimine ligand to the monohydric phenol is (0.001˜0.05):1.

Preferably, in step 1) of the synthesizing method, the solvent is C₆˜C₁₈ aromatic hydrocarbon, or a mixed solvent of C₆˜C₁₈ aromatic hydrocarbon and C₁˜C₁₀ alkyl alcohol. More preferably, the solvent is one selected from the group consisting of toluene, xylene, a mixed solvent of toluene and methanol, and a mixed solvent of toluene and ethanol; further more preferably, the solvent is one selected from the group consisting of toluene, a mixed solvent of toluene and methanol.

Preferably, in step 1) of the synthesizing method, the metal salt solution is a hydrogen halide solution of metal halide; further preferably, the metal salt solution is one selected from the group consisting of a hydrochloric acid solution of cuprous chloride, a hydrobromic acid solution of cuprous bromide; the hydrochloric acid solution of cuprous chloride can be prepared by using cuprous oxide and hydrochloric acid; the hydrobromic acid solution of cuprous bromide can be prepared by using cuprous oxide and hydrobromic acid.

Preferably, in step 1) of the synthesizing method, the oxidant is oxygen, air, or a mixed gas composed of oxygen and inert gas; further preferably, the oxidant is oxygen.

Preferably, in step 1) of the synthesizing method, the oxidative copolymerization reaction performed under the action of the oxidant specifically refers to the oxidative copolymerization reaction performed by passing oxygen gas; and the flow rate of oxygen is 100 sccm-300 sccm.

Preferably, in step 1) of the synthesizing method, the reactor is equipped with a reflux condensation unit.

Preferably, in step 1) of the synthesizing method, the temperature of the oxidative copolymerization reaction is 20° C.˜60° C.; the time of the oxidative copolymerization reaction is 1 hour-3 hours.

Preferably, in step 2) of the synthesizing method, the chelating agent is at least one selected from the group consisting of nitrilotriacetate and ethylenediamine tetraacetate; further preferably, the chelating agent is at least one selected from the group consisting of nitrilotriacetate sodium salt and ethylenediamine tetraacetate sodium salt.

Preferably, in step 2) of the synthesizing method, the temperature of the reaction is 50° C.˜90° C.; the time of the reaction is 30 minutes˜180 minutes.

Preferably, in step 2) of the synthesizing method, separating and extracting the oil phase product is specifically conducted by removing the water phase by a liquid-liquid centrifugal separation method, thereby obtaining the oil phase product.

Preferably, in step 3) of the synthesizing method, concentrating and purifying the oil phase product is specifically conducted by the following processes: evaporating and concentrating the oil phase product, then adding into a nonsolvent of the polyphenylene oxide, precipitating out, separating, washing, and drying; more preferably, the nonsolvent of the polyphenylene oxide is C₁˜C₁₀ alkyl alcohol; further more preferably, the nonsolvent of polyphenylene oxide is methanol.

The present disclosure has the following beneficial effects.

The present disclosure provides a method for synthesizing dihydroxyl-terminated polyphenylene oxide oligomer. The method uses a metal-polyethyleneimine complex as a catalyst, which has a milder catalytic activity, can effectively promote the relation between the dihydric phenol and the monohydric phenol, increases the hydroxyl content of the product, meanwhile reduces the amount of the residual dihydric phenol monomer in the product, so that the quality of the product can be improved. The dihydroxyl-terminated polyphenylene oxide oligomer prepared by the present disclosure can be used as additive and copolymer block in other thermoplastics, thermoplastic elastomers and thermosetting materials, thereby improving the properties of the material, such as thermal property, adhesion, mechanical property, and chemical resistance, and electrical property, and the like.

### BRIEF DESCRIPTION OF THE DRAWINGS

FIG. 1 is the infrared spectrum of Example 1.

### DETAILED DESCRIPTION

The content of the present disclosure will be further described in detail below via specific examples. The raw materials used in the examples can be obtained from a conventional commercial way, unless otherwise indicated.

### Example 1

A method for synthesizing dihydroxyl-terminated polyphenylene oxide oligomer, comprised the following steps:

1) adding 335.50 g of 2,6-dimethylphenol, 57.00 g of bisphenol A, 779.13 g of toluene and 114.00 g of methanol into a reactor equipped with a reflux condensation unit, stirring until all the monomers were dissolved, then adding 16.50 g of dodecyl polyethyleneimine ligand (Mₙ=2000) and 6.17 g of the hydrobromic acid solution of cuprous bromide (prepared freshly by using 0.45 g of cuprous oxide and 5.72 g of 48% hydrobromic acid), mixing well, then passing oxygen (flow rate was 200 sccm), and reacting at 40° C. for 150 minutes;

2) adding the polymer solution after completion of the reaction into 50.81 mL of 10% nitrilotriacetic acid trisodium salt solution, reacting at 70° C. for 60 minutes, and then subjecting to liquid-liquid centrifugation to remove the water phase;

3) concentrating the oil phase obtained by centrifugation in step 2) to about 900 mL, adding 9000 mL of methanol, precipitating out, filtering, washing 3 times with methanol, and drying under vacuum at 80° C. overnight, to obtain the dihydroxyl-terminated polyphenylene oxide oligomer of Example 1.

### Example 2

A method for synthesizing the dihydroxyl-terminated polyphenylene oxide oligomer, comprised the following steps:

1) adding 305.00 g of 2,6-dimethylphenol, 47.33 g of tetramethylbisphenol A, 942.62 g of toluene and 94.00 g of methanol into a reaction kettle equipped with a reflux condensation unit, stirring until all the monomers were dissolved, then adding 12.53 g of branched polyethyleneimine ligand (Mₙ=600) and 4.11 g of the hydrobromic acid solution of cuprous bromide (prepared freshly by using 0.30 g of cuprous oxide and 3.81 g of 48% hydrobromic acid), mixing well, then passing oxygen (the flow rate was 200 sccm), and reacting at 40° C. for 150 minutes;

2) adding the polymer solution after completion of the reaction into 33.87 mL of 10% nitrilotriacetic acid trisodium salt solution, reacting at 70° C. for 60 minutes, and then subjecting to liquid-liquid centrifugation to remove the water phase;

3) concentrating the oil phase obtained by centrifugation in step 2) to about 900 mL, adding 9000 mL of methanol, precipitating out, filtering, washing 3 times with methanol, and drying under vacuum at 80° C. overnight, to obtain the dihydroxyl-terminated polyphenylene oxide oligomer of Example 2.

### Example 3

A method for synthesizing the dihydroxyl-terminated polyphenylene oxide oligomer, comprised the following steps:

1) adding 341.60 g of 2,6-dimethylphenol, 80.00 g of bisphenol F, 801.26 g of toluene and 160.00 g of methanol into a reaction kettle equipped with a reflux condensation unit, stirring until all the monomers were dissolved, then adding 16.85 g of linear polyethyleneimine ligand (Mₙ=1200) and 5.22 g of the hydrochloric acid solution of cuprous chloride (prepared freshly by using 0.60 g cuprous oxide and 4.62 g 37% hydrochloric acid), mixing well, then passing oxygen (the flow rate was 200 sccm), and reacting at 45° C. for 150 minutes;

2) adding the polymer solution after completion of the reaction into 33.87 mL of 20% nitrilotriacetic acid trisodium salt solution, reacting at 70° C. for 60 minutes, and then subjecting to liquid-liquid centrifugation to remove the water phase;

3) concentrating the oil phase obtained by centrifugation in step 2) to about 900 mL, adding 9000 mL of methanol, precipitating out, filtering, washing 3 times with methanol, and drying under vacuum at 80° C. overnight, to obtain the dihydroxyl-terminated polyphenylene oxide oligomer of Example 3.

### Example 4

A method for synthesizing the dihydroxyl-terminated polyphenylene oxide oligomer, comprised the following steps:

1) adding 325.00 g of 2,6-dimethylphenol, 76.00 g of bisphenol A, 767.02 g of toluene and 152.00 g of methanol into a reaction kettle equipped with a reflux condensation unit, stirring until all the monomers were dissolved, then adding 15.33 g of branched polyethyleneimine ligand (Mₙ=800) and 6.17 g of the hydrobromic acid solution of cuprous bromide (prepared freshly by using 0.45 g of cuprous oxide and 5.72 g of 48% hydrobromic acid), mixing well, then passing oxygen (flow rate was 200 sccm), and reacting at 45° C. for 150 minutes;

2) adding the polymer solution after completion of the reaction into 50.25 mL of 20% ethylenediaminetetraacetic acid tetrasodium salt solution, reacting at 70° C. for 60 minutes, and then subjecting to liquid-liquid centrifugation to remove the water phase;

3) concentrating the oil phase obtained by centrifugation in step 2) to about 900 mL, adding 9000 mL of methanol, precipitating out, filtering, washing 3 times with methanol, and drying under vacuum at 80° C. overnight, to obtain the dihydroxyl-terminated polyphenylene oxide oligomer of Example 4.

### Comparative Example 1

The dodecyl polyethyleneimine ligand of Example 1 was changed to N,N-dimethyl n-butylamine with an equimolar N content, and the other materials and reaction conditions remained unchanged.

### Comparative Example 2

The branched polyethyleneimine ligand of Example 2 was changed to di-n-butylamine with an equimolar N content, and the other materials and reaction conditions remained unchanged.

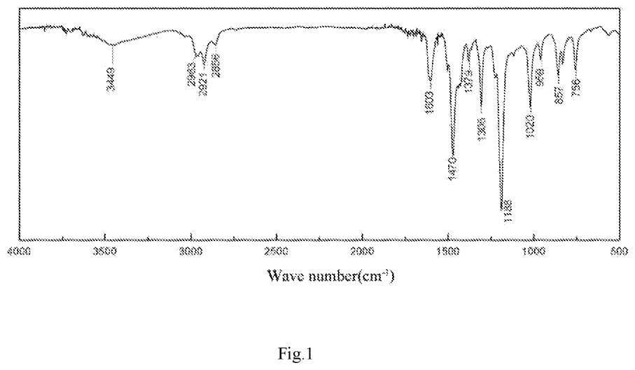

FIG. 1 showed the infrared spectrum of the dihydroxyl-terminated polyphenylene oxide oligomer of Example 1. In FIG. 1, 1305 cm⁻¹, 1188 cm⁻¹, 1020 cm⁻¹ were the characteristic absorption peaks of benzene ring C—O vibration; 1603 cm⁻¹ and 1470 cm⁻¹ were the characteristic absorption peaks of stretching vibration of benzene ring skeleton C═C; 2963 cm⁻¹ and 2856 cm⁻¹ were the characteristic absorption peak of stretching vibration of methyl C—H on the benzene ring; 1379 cm⁻¹ was the characteristic absorption peak of flexural vibration of methyl C—H on the benzene ring, and 857 cm⁻¹ was the characteristic absorption peak of flexural vibration of C—H on the benzene ring. The infrared spectrum was consistent with the standard infrared spectrum of polyphenylene oxide, indicating that the method of the present disclosure can be used to effectively prepare the polyphenylene oxide products.

Table 1 showed the performance testing results of the polyphenylene oxide products obtained in Examples 1˜4 and Comparative Examples 1˜2.

TABLE 1
The performance testing results of the polyphenylene oxide products
obtained in Examples 1~4 and Comparative Examples 1~2

| | | Number | | | | | |
|---|---|---|---|---|---|---|---|
| | | average | Glass | | | Residual monomer | |
| | Intrinsic | molecular | transition | Hydroxyl | hydroxyl- | (wt %) | |
| Example | viscosity | weight | temperature | equivalent | terminated | Dihydric | Monohydric |
| No. | (dl/g) | (g/mol) | (° C.) | (g/mol) | functionality | phenol | phenol |
| Example 1 | 0.09 | 1600 | 140 | 845 | 1.89 | 1.5 | <0.05 |
| Example 2 | 0.10 | 2100 | 145 | 1080 | 1.94 | 0.8 | <0.05 |
| Example 3 | 0.06 | 1050 | 115 | 580 | 1.81 | 1.9 | <0.05 |
| Example 4 | 0.07 | 1200 | 125 | 630 | 1.90 | 1.1 | <0.05 |
| Comparative | 0.10 | 1950 | 150 | 1050 | 1.86 | 8.7 | <0.05 |
| Example 1 | | | | | | | |
| Comparative | 0.11 | 2150 | 155 | 1130 | 1.90 | 2.5 | <0.05 |
| Example 2 | | | | | | | |

It could be seen from the testing results, the polyphenylene oxide product prepared by the present disclosure had a low molecular weight, an intrinsic viscosity of less than 0.10 dl/g, and a hydroxyl-terminate functionality of greater than 1.8, indicating that the method of the present disclosure can be used to effectively prepare dihydroxyl-terminated polyphenylene oxide oligomer. Moreover, compared with the metal-small molecule ligand catalyst system, by using a metal-polyethyleneimine complex as a catalyst, the amount of the residual dihydric phenol monomer in the product was significantly reduced.

The polyphenylene oxide product prepared by the present disclosure had low number average molecular weight, high hydroxyl functionality, and less dihydric phenol monomer residue, and could be used as additives and copolymer blocks for various thermoplastics, thermoplastic elastomers and thermosetting materials, thereby improving the performances of materials, such as the thermal properties, adhesion, mechanical property, chemical resistance and electrical property. The polyphenylene oxide product prepared by the present disclosure can be widely used in the fields such as electronics and electrical, automobile industries, and machinery manufacturing.

The above-mentioned examples are only used to assist understanding the method and core idea of the present disclosure. The embodiments of the present disclosure are not limited to the above-mentioned examples, and any other changes, modifications, substitutions, combinations, and simplifications made without departing from the spirit and principle of the present disclosure should all be equivalent replacements, and they are all included in the protection scope of the present disclosure.

1. A method for synthesizing dihydroxyl-terminated polyphenylene oxide oligomer, comprising oxidatively copolymerizing monohydric phenol and dihydric phenol in the presence of metal-polyethyleneimine complex as a catalyst, to obtain the dihydroxyl-terminated polyphenylene oxide oligomer; and
the structure of the dihydroxyl-terminated polyphenylene oxide oligomer is as shown in formula (I): 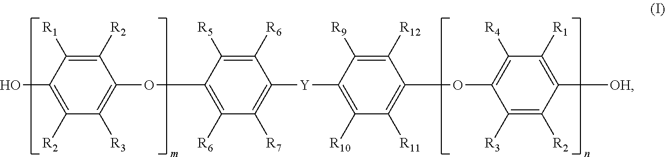
wherein, in formula (I), m and n are respectively an integer greater than or equal to 0,
R₁, R₂, R₃, R₄, R₅, R₆, R₇, R₈, R₉, R₁₀, R₁₁, or R₁₂ independently represents a hydrogen atom, an alkyl group, a phenyl group, an alkoxy group, an aminoalkyl group, halogen or a halogenated alkyl group,
Y has a structure selected from the following: 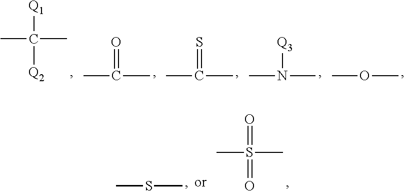
or Y is not present, wherein Q₁, Q₂, or Q₃ respectively independently represents a hydrogen atom, an alkyl group or a halogenated alkyl group;
the number average molecular weight of the dihydroxyl-terminated polyphenylene oxide oligomer is 800˜8000.

2. The method for synthesizing dihydroxyl-terminated polyphenylene oxide oligomer according to claim 1, wherein the metal-polyethyleneimine complex is a complex formed from a metal salt and a polyethyleneimine ligand; the metal salt is at least one selected from the group consisting of copper salt, manganese salt, cobalt salt, and iron salt; the polyethyleneimine ligand is at least one selected from the group consisting of linear polyethyleneimine, branched polyethyleneimine, and alkylated polyethyleneimine.

3. The method for synthesizing dihydroxyl-terminated polyphenylene oxide oligomer according to claim 2, wherein in the metal-polyethyleneimine complex, the number average molecular weight of the polyethyleneimine ligand is 500˜10000.

4. The method for synthesizing dihydroxyl-terminated polyphenylene oxide oligomer according to claim 2, wherein in the metal-polyethyleneimine complex, the molar ratio of polyethyleneimine ligand to metal is (0.3˜15):1.

5. The method for synthesizing dihydroxyl-terminated polyphenylene oxide oligomer according to claim 1, wherein the structure of the monohydric phenol is as shown in formula (II): 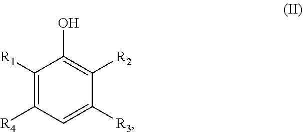
in the formula (II), R₁, R₂, R₃, or R₄ respectively independently represents a hydrogen atom, an alkyl group, a phenyl group, an alkoxy group, an aminoalkyl group, halogen or a halogenated alkyl group;
the structure of the dihydric phenol is as shown in formula (III): 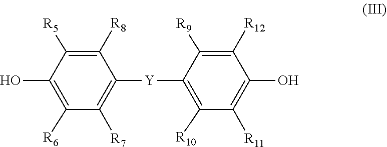
in the formula (III), R₅, R₆, R₇, R₈, R₉, R₁₀, R₁₁, or R₁₂ respectively independently represents a hydrogen atom, an alkyl group, a phenyl group, an alkoxy group, an aminoalkyl group, halogen or a halogenated alkyl group;
Y has a structure selected from the following: 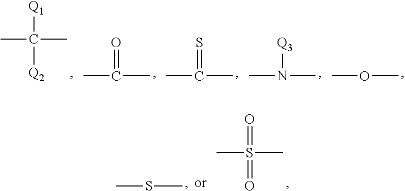
or Y is not present, wherein Q₁, Q₂, or Q₃ respectively independently represents a hydrogen atom, an alkyl group or a halogenated alkyl group.

6. The method for synthesizing dihydroxyl-terminated polyphenylene oxide oligomer according to claim 1, specifically comprising the following steps:
1) in a reaction kettle, dissolving the monohydric phenol and the dihydric phenol in a solvent, adding a solution of the polyethyleneimine ligand and the metal salt, and performing an oxidative copolymerization reaction under the action of an oxidant, to obtain a polymer solution;
2) mixing and reacting the polymer solution obtained in step 1) with a chelating agent solution, then separating and extracting an oil phase product;
3) concentrating and purifying the oil phase product obtained in step 2), to obtain the dihydroxyl-terminated polyphenylene oxide oligomer having the structure of formula (I).

7. The method for synthesizing dihydroxyl-terminated polyphenylene oxide oligomer according to claim 6, wherein in step 1), the molar ratio of the monohydric phenol to the dihydric phenol is (2˜20):1; the molar ratio of the polyethyleneimine ligand to the monohydric phenol is (0.001˜0.05):1.

8. The method for synthesizing dihydroxyl-terminated polyphenylene oxide oligomer according to claim 6, wherein in step 1), the solvent is C₆˜C₁₈ aromatic hydrocarbon, or a mixed solvent of C₆˜C₁₈ aromatic hydrocarbon and C₁˜C₁₀ alkyl alcohol; the oxidant is oxygen, air, or a mixed gas composed of oxygen and inert gas.

9. The method for synthesizing dihydroxyl-terminated polyphenylene oxide oligomer according to claim 7, wherein in step 1), the temperature of the oxidative copolymerization reaction is 20° C.˜60° C.; the time of the oxidative copolymerization reaction is 1 hour˜3 hours.

10. The method for synthesizing dihydroxyl-terminated polyphenylene oxide oligomer according to claim 6, wherein in step 2), the chelating agent is at least one selected from the group consisting of nitrilotriacetate and ethylenediaminetetraacetate.
